(19) United States
(12) Patent Application Publication
(10) Pub. No.: US 2023/0035836 A1
(43) Pub. Date: Feb. 2, 2023

(54) DATA ANALYSIS DEVICE AND MODEL MANAGEMENT METHOD

(71) Applicant: Hitachi, Ltd., Tokyo (JP)

(72) Inventors: Takumi OTA, Tokyo (JP); Daisuke INABA, Tokyo (JP); Masatoshi IWAIDA, Tokyo (JP); Daisuke YAMAZAKI, Tokyo (JP)

(21) Appl. No.: 17/832,788

(22) Filed: Jun. 6, 2022

(30) Foreign Application Priority Data
Aug. 2, 2021 (JP) 2021-126515

(51) Int. Cl. G06F 16/28

(52) U.S. Cl. CPC G06F 16/285

(57) ABSTRACT

A sequential data analysis unit that cyclically generates a model for analyzing time-series data representing an operational status of an analysis target system using a clustering technology; and a management unit that manages the model, parameter information of the model, a classification result of the time-series data by the clustering technology, and version information given each time the model is generated are included. Then, when the version information of the model is selected, the management unit executes processing of regenerating the model by using the parameter information associated with the selected version information and the classification result of the time-series data.

### CROSS-REFERENCE TO RELATED APPLICATION

The present application claims priority from Japanese application JP2021-126515, filed on Aug. 2, 2021, the contents of which is hereby incorporated by reference into this application.

### BACKGROUND OF THE INVENTION

### 1. Field of the Invention

The present invention relates to a data analysis device and a model management method using a learned model.

### 2. Description of the Related Art

A technology for managing a learned model includes a technique disclosed in JP 2021-22311 A. JP 2021-22311 A discloses an abnormality detecting device that also stores, as a label, a feature of data used to generate a plurality of learned models when managing the plurality of learned models. This configuration makes it possible for an abnormality analysis device, by using the given label, to search for learned model to be used when actually performing data analysis. It can be deemed that a point of the abnormality analysis device disclosed in JP 2021-22311 A is that the learned model and the information regarding the data used for the learning are stored together.

### SUMMARY OF THE INVENTION

However, in the case of an algorithm that sequentially generates (updates category) a learned model such as the adaptive resonance theory, there is a demand for returning the learned model to a certain state, but it is difficult to handle the technology disclosed in JP 2021-22311 A.

In view of the above circumstance, there has been a demand for a method capable of returning a learned model used for data analysis to a discretionary state.

In order to solve the above problem, a data analysis device according to one aspect of the present invention includes: a sequential data analysis unit that cyclically generates a model for analyzing time-series data representing an operational status of an analysis target system using a clustering technology; and a management unit that manages the model, parameter information of the model, a classification result of the time-series data by the clustering technology, and version information given each time the model is generated. Then, when the version information of the model is selected, the management unit executes processing of regenerating the model by using the parameter information associated with the selected version information and the classification result of the time-series data.

According to at least one aspect of the present invention, it is possible to return (for example, performing duplication and restoration) the learned model used for data analysis to a discretionary state.

Problems, configurations, and effects other than those described above will be made clear by the following description of embodiment.

### BRIEF DESCRIPTION OF THE DRAWINGS

FIG. 1 is a schematic diagram illustrating an overall configuration example of a system to which a data analysis device according to an embodiment of the present invention is applied;

FIG. 2 is a diagram illustrating an example of a structure of a learning data management table according to the embodiment of the present invention;

FIG. 3 is a diagram illustrating an example of a structure of a diagnosis group management table according to the embodiment of the present invention;

FIG. 4 is a diagram illustrating an example of a structure of a model management table according to the embodiment of the present invention;

FIG. 5 is a diagram illustrating an example of a structure of a version management table according to the embodiment of the present invention;

FIG. 6 is a diagram illustrating an example of a structure of a diagnosis data management table according to the embodiment of the present invention;

FIG. 7 is a diagram illustrating an example of a structure of a diagnosis result data management table according to the embodiment of the present invention;

FIG. 8 is a flowchart presenting a procedure example of model management processing by the data analysis device according to the embodiment of the present invention;

FIG. 9 is a flowchart presenting a procedure example of learning category information generation processing according to the embodiment of the present invention;

FIG. 10 is a diagram illustrating an example of a diagnosis group information input screen according to the embodiment of the present invention;

FIG. 11 is a diagram illustrating an example of a parameter information input screen according to the embodiment of the present invention;

FIG. 12 is a diagram illustrating an example of a manual/automatic diagnosis setting screen according to the embodiment of the present invention;

FIG. 13 is a flowchart presenting a procedure example of manual diagnosis processing according to the embodiment of the present invention;

FIG. 14 is a diagram illustrating an example of a manual diagnosis execution model selection screen according to the embodiment of the present invention;

FIG. 15 is a diagram illustrating an example of a learning/diagnosis execution category information screen according to the embodiment of the present invention;

FIG. 16 is a flowchart presenting a procedure example of online diagnosis processing according to the embodiment of the present invention;

FIG. 17 is a view illustrating an example of a labeling screen according to the embodiment of the present invention;

FIG. 18 is a flowchart (1) presenting a procedure example of model regeneration processing according to the embodiment of the present invention;

FIG. 19 is a flowchart (2) presenting the procedure example of the model regeneration processing according to the embodiment of the present invention;

FIG. 20 is a view illustrating an example of a model regeneration screen according to the embodiment of the present invention; and

FIG. 21 is a flowchart presenting a procedure example of automatic deletion processing according to the embodiment of the present invention.

### DESCRIPTION OF THE PREFERRED EMBODIMENTS

Examples of an embodiment for carrying out the present invention will be described below with reference to the accompanying drawings. In the present description and the accompanying drawings, components having substantially identical function or configuration are denoted by the identical reference numerals, and redundant description is omitted.

### [Overall System Including Data Analysis Device]

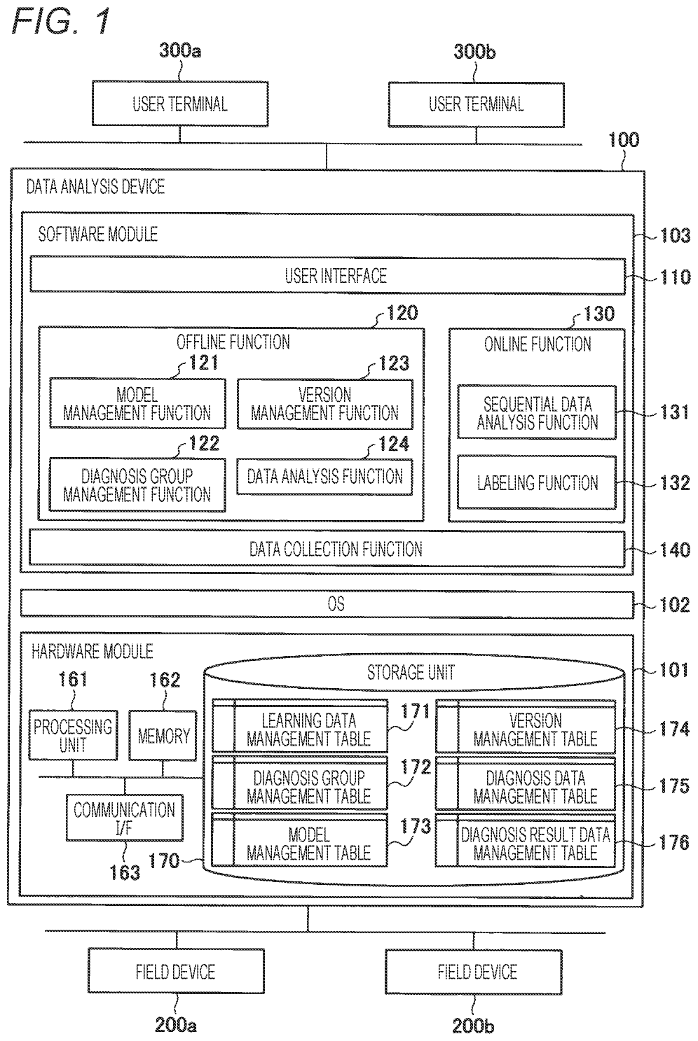

First, an example of a system to which the data analysis device according to the embodiment of the present invention is applied will be described with reference to FIG. 1.

FIG. 1 is a schematic diagram illustrating an overall configuration example of the system to which the data analysis device according to the embodiment of the present invention is applied. FIG. 1 also illustrates a configuration example of a data analysis device 100.

The data analysis device 100 is connected to field devices 200a and 200b via a network. The field devices 200a and 200b are components existing in a control system of an analysis target, and correspond to devices such as SCADA and a controller. The data analysis device 100 is accessed from user terminals 300a and 300b via a network. The user terminals 300a and 300b are terminals used by the user, and correspond to a personal computer, a tablet computer, or the like that includes an input device and a display device. With the input device of the user terminal 300, the user can perform display of each screen described later on the display device, movement of a pointer, clicking, input of text, and the like on each screen.

The field devices 200a and 200b and the user terminals 300a and 300b are described as the field device 200 and the user terminal 300, respectively, when not distinguished between the field devices 200a and 200b and between the user terminals 300a and 300b. The numbers of the field devices 200 and the user terminals 300 are not limited to those illustrated in FIG. 1.

Note that in the present embodiment, the adaptive resonance theory (ART) will be described as an example of a mechanism (clustering technology) for classifying time-series data. The adaptive resonance theory is a type of machine learning that classifies a plurality of pieces of time-series data into a plurality of categories (clusters). Although the adaptive resonance theory is used in the present embodiment, other clustering technologies may be used.

In the adaptive resonance theory, first, category information serving as a reference is generated using time-series data. The category information serving as a reference is a result of classifying, into several categories, the time-series data having been used. This phase is called “learning”. The time-series data used at the time of learning is called “learning data”.

After learning, processing of generating category information is performed using the category information generated at the time of learning and the time-series data having the same data structure as that of the learning data. This phase is called “diagnosis”. The time-series data used at the time of diagnosis is called “diagnosis data”.

In diagnosis, diagnosis data that cannot be included in the category at the time of learning is found. For diagnosis data that cannot be included in the category at the time of learning, a new category is generated. Therefore, when diagnosis is performed, the category information (classification) sometimes changes. As described below, by storing the category information before diagnosis, it is possible to return the category information that has changed after diagnosis.

On the other hand, the distribution of the category greatly changes depending on the parameters of the model used at the time of learning. Therefore, it is necessary to determine whether to be an appropriate parameter by seeing the distribution of the category after learning. It is necessary to manage, compare, and consider the parameters set at the time of learning and the category information after learning together.

What includes learning data, parameters used at the time of learning, and category information after learning/diagnosis is defined as a model. The present invention relates to a model management method for improving model operation efficiency.

### [Data Analysis Device]

The data analysis device 100 corresponds to a personal computer and another general-purpose computer, a workstation, and the like. The data analysis device 100 is configured to include a hardware module 101, an OS 102, and a software module 103.

The hardware module 101 includes a processing unit 161 including a central processing unit (CPU), a memory 162 for operating an OS, a computer program, and the like, a communication interface (in the figure, communication I/F) 163 for communicating with the field device 200 and the user terminal 300, a storage unit 170 such as a large-capacity storage. Each block is connected to be able to transmit and receive data to and from each other via a system bus.

The storage unit 170 stores a learning data management table 171, a diagnosis group management table 172, a model management table 173, a version management table 174, a diagnosis data management table 175, and a diagnosis result data management table 176. The storage unit 170 stores a computer program, parameters, a model, and the like executed by the processing unit 161. The processing unit 161 reads, from the storage unit 170, and executes a program code of software for implementing each function according to the present embodiment to perform various arithmetic operations and controls.

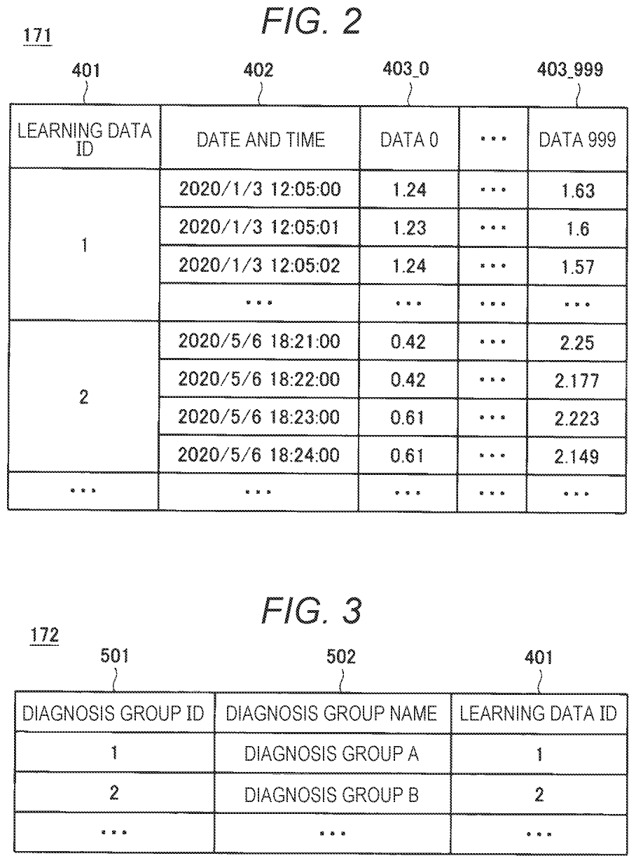

Next, the learning data management table 171, the diagnosis group management table 172, the model management table 173, the version management table 174, the diagnosis data management table 175, and the diagnosis result data management table 176 will be described with reference to FIGS. 2 to 7.

### [Learning Data Management Table]

FIG. 2 is a diagram illustrating an example of the structure of the learning data management table 171.

The learning data management table 171 is a table that manages learning data. The learning data management table 171 includes fields of “learning data ID 401”, “date and time 402”, “learning data 403_0”, . . . , and “learning data 403_999”. When the learning data 403_0, the learning data 403_1, . . . , and the learning data 403_999 are described as the learning data 403 when not distinguished.

The learning data ID 401 is an identifier for uniquely identifying the learning data, and the learning data ID 401 is given each time learning data is added.

The date and time 402 is information regarding the date and time when the learning data 403 is generated, the information given to the learning data 403 by the user or the field device 200.

The learning data 403 is time-series data output from the field device 200, and corresponds to information such as temperature, pressure, flow rate, speed, current, and voltage.

### [Diagnosis Group Management Table]

FIG. 3 is a diagram illustrating an example of the structure of the diagnosis group management table 172.

The diagnosis group management table 172 is a table that stores information regarding a diagnosis group that manages category information in units of learning data. The diagnosis group management table 172 has fields of “diagnosis group ID 501”, “diagnosis group name 502”, and “learning data ID 401”.

The diagnosis group ID 501 is an identifier for uniquely identifying the diagnosis group, and is given each time the user generates new category information using learning data. For example, the diagnosis group is set in units of system or equipment of the analysis target. The diagnosis group name 502 is a name of a diagnosis group input by the user at the time of generation of the category information. As an example, when a name causing learning data to be recalled is used as a diagnosis group name, the diagnosis group name is displayed on the user terminal 300, and the operation efficiency is improved.

### [Model Management Table]

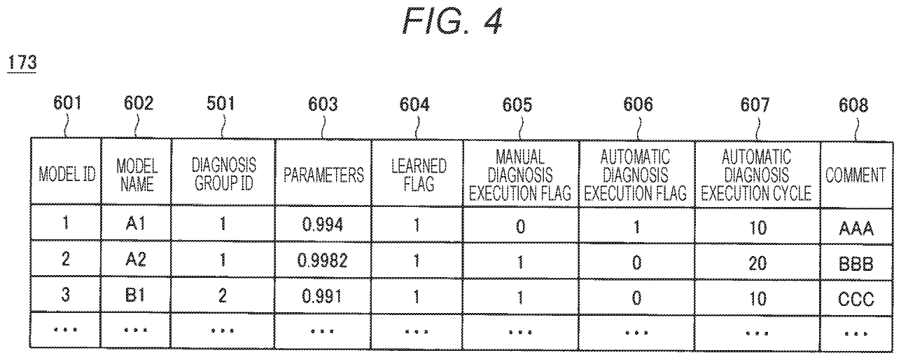

FIG. 4 is a diagram illustrating an example of the structure of the model management table 173.

The model management table 173 is a table that manages information necessary for generation of a model. The model management table 173 includes fields of “model ID 601”, “model name 602”, “diagnosis group ID 501”, “parameter 603”, “learned flag 604”, “manual diagnosis execution flag 605”, “automatic diagnosis execution flag 606”, “automatic diagnosis execution cycle 607”, and “comment 608”.

The model ID 601 is an identifier for uniquely identifying the model, and is given when the user generates category information using the learning data.

The model name 602 is the name of a model input by the user when the model is generated.

The parameter 603 is a parameter used when category information is generated using learning data and diagnosis data.

The learned flag 604 is a flag indicating whether or not the corresponding model has executed learning.

The manual diagnosis execution flag 605 is a flag indicating whether or not diagnosis is manually executed using the corresponding model.

The automatic diagnosis execution flag 606 is a flag indicating whether or not diagnosis is automatically executed using the corresponding model.

The automatic diagnosis execution cycle 607 stores a cycle when diagnosis is automatically executed using the corresponding model.

The comment 608 stores text information input by the user regarding the corresponding model.

### [Version Management Table]

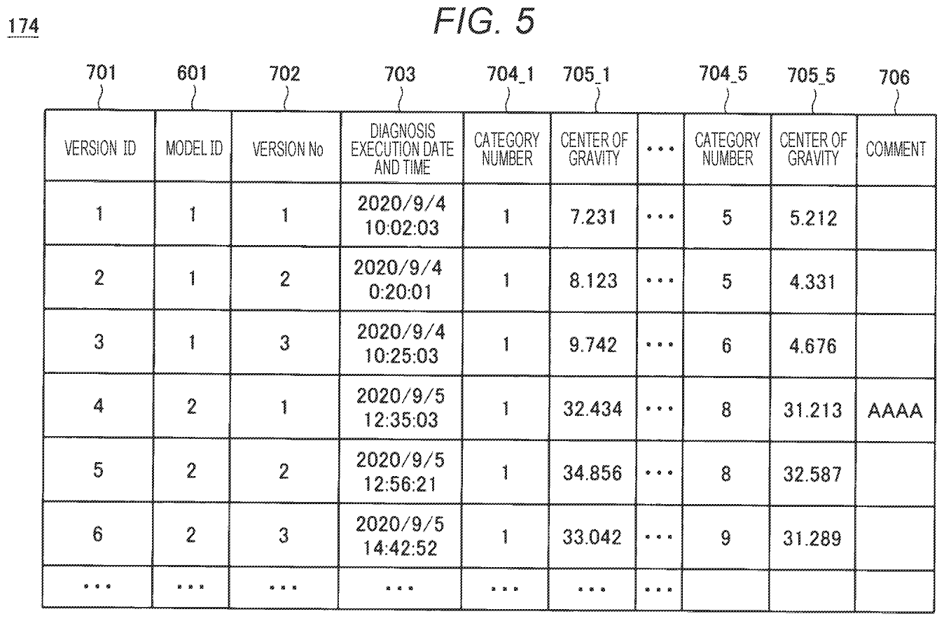

FIG. 5 is a diagram illustrating an example of the structure of the version management table 174.

The version management table 174 is a table that stores a result of diagnosis using the category information and the diagnosis data generated at the time of learning the model. The version management table 174 includes fields of “version ID 701”, “model ID 601”, “version No. 702”, “diagnosis execution date and time 703”, “category number 704”, “center of gravity 705”, and “comment 706”.

The version ID 701 is an identifier for uniquely identifying the result of execution of a diagnosis using diagnosis data, and is given each time a diagnosis using diagnosis data is executed.

The version No. 702 is an identifier for uniquely identifying the diagnosis result of the identical model indicated by the model ID 601, and is given each time diagnosis using diagnosis data is executed.

The diagnosis execution date and time 703 is information regarding the date and time when diagnosis is executed using the corresponding model.

Each of the category number 704 and the center of gravity 705 is an element of category information output when the adaptive resonance theory is executed. FIG. 5 illustrates an example of category numbers 704_1 to 704_5 and centers of gravity 705_1 to 705_5. When simply referred to as category in the present description, the category basically refers to a category number.

The comment 706 stores text information input by the user regarding the diagnosis result of the corresponding model.

As described above, in the present embodiment, the version information is the date and time when classification of the diagnosis data is executed by the clustering technology (for example, adaptive resonance theory) using the classification result of the time-series data when the model is learned and the diagnosis data that is time-series data having the same structure as that at the time of learning.

### [Diagnosis Data Management Table]

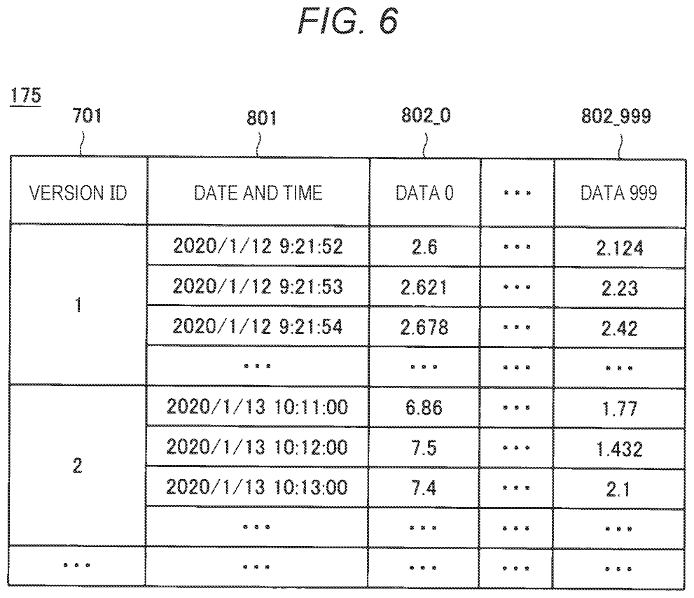

FIG. 6 is a diagram illustrating an example of the structure of the diagnosis data management table 175.

The diagnosis data management table 175 is a table for managing diagnosis data. The diagnosis data management table 175 includes fields of “version ID 701”, “date and time 801”, “diagnosis data 802_0”, . . . , and “diagnosis data 802_999”. When the diagnosis data 802_0, the diagnosis data 802_1, . . . , and the diagnosis data 802_999 are described as the diagnosis data 802 when not distinguished.

The date and time 801 is information regarding the date and time when the diagnosis data 802 is generated, the information given to the diagnosis data 802 by the user or the field device 200.

The diagnosis data 802 is time-series data output from the field device 200, and corresponds to information such as temperature, pressure, and flow rate.

### [Diagnosis Result Data Management Table]

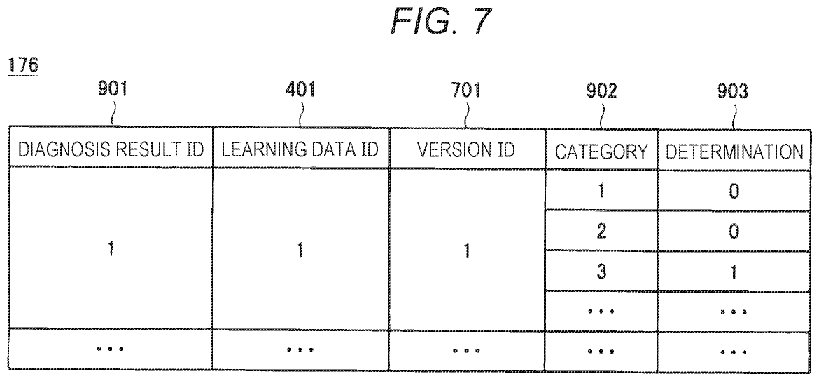

FIG. 7 is a diagram illustrating an example of the structure of the diagnosis result data management table 176.

The diagnosis result data management table 176 is a table that stores a result of labeling, by the user, whether a category classified after learning or after diagnosis is a category generated at a normal time or a category generated at an abnormal time. The diagnosis result data management table 176 includes fields of “diagnosis result ID 901”, “learning data ID 401”, “version ID 701”, “category 902”, and “determination 903”.

The diagnosis result ID 901 is an identifier for uniquely identifying the diagnosis result and is given for each diagnosis execution.

The category 902 indicates category information (category number) output when the adaptive resonance theory is executed.

The determination 903 stores a result of determination made by the user on whether the category information is a normal category or an abnormal category for each piece of category information (category number in this figure) indicated in the category 902.

As described above, in the data analysis device 100 according to the present embodiment, the management unit (for example, an offline function 120 (for example, the diagnosis result data management table 176)) manages the category of the time-series data (diagnosis data) and the determination results of normality or abnormality for each category in association with the version information.

The above is the description of each management table stored in the storage unit 170. Returning to the description of the configuration of the data analysis device 100 illustrated in FIG. 1.

The OS 102 is basic software (operating system) that comprehensively controls the operation of the data analysis device 100.

The software module 103 is software that operates on the data analysis device 100, and includes a user interface 110, the offline function 120, an online function 130, and a data collection function 140.

The user interface 110 is an interface for the user to operate the user terminal 300 to use the offline function 120 and the online function 130, and corresponds to a web interface or the like.

### [Offline Function]

The offline function 120 is a function of using time-series data acquired in advance from the field device 200 to perform learning and diagnosis by a model, and includes a model management function 121, a diagnosis group management function 122, a version management function 123, and a data analysis function 124.

The model management function 121 is a function for the user to generate and edit the model management table 173 using the user interface 110.

The diagnosis group management function 122 is a function for the user to generate and edit the learning data management table 171 and the diagnosis group management table 172 using the user interface 110.

The version management function 123 is a function for the user to refer to or update the version management table 174 using the user interface 110.

The data analysis function 124 executes the adaptive resonance theory with reference to the information regarding the diagnosis group stored in the diagnosis group management table 172, and stores category information that is a result of the execution into the version management table 174 for each diagnosis version. The data analysis function 124 is a function of storing diagnosis data used for the execution into the diagnosis data management table 175 for each diagnosis version.

### [Online Function]

The online function 130 is a function of cyclically performing diagnosis by a model using time-series data periodically acquired from the field device 200 using the data collection function 140, and includes a sequential data analysis function 131 and a labeling function 132.

The sequential data analysis function 131 is a function of periodically executing the adaptive resonance theory with time-series data acquired from the field device 200 using the data collection function 140 as diagnosis data with reference to the information regarding the diagnosis group stored in the diagnosis group management table 172. The sequential data analysis function 131 is a function of storing category information that is a result of the execution into the version management table 174 and the diagnosis result data management table 176, and storing diagnosis data into the diagnosis data management table 175.

The labeling function 132 is a function of updating the diagnosis result data management table 176 by the user using the user interface 110.

The data collection function 140 is a function of periodically collecting time-series data from the field device 200 through the communication I/F 163. The cycle of collection, the type of data to be collected, and the like are set by the user using a setting file or the like. The data collection function 140 stores collected time-series data into the memory 162 or the storage unit 170 in a format that can be used by the sequential data analysis function 131. The sequential data analysis function 131 reads time-series data stored in the memory 162 or the storage unit 170 to execute the periodic adaptive resonance theory. The above is the description of the configuration of the data analysis device 100.

As described above, the data analysis device (the data analysis device 100) according to the present embodiment includes the sequential data analysis unit (the sequential data analysis function 131 of the online function 130) that cyclically generates a model for analyzing time-series data representing the operational status of a target system using a clustering technology (for example, adaptive resonance theory), and the management unit (the offline function 120 (for example, the model management function 121)) that manages the model, the parameter information of the model, a classification result (the category number 704) of the time-series data (the diagnosis data 802) by the clustering technology, and version information (the version ID 701) given each time the model is generated. The management unit is configured to, when the version information of the model is selected, execute processing of regenerating the model by using the parameter information (parameter 603) associated with the selected version information and the classification result (category number 704) of the time-series data.

The data analysis device according to the present embodiment configured as described above can return the learned model used for data analysis to a discretionary state on the basis of the selected version information. This makes it possible to flexibly operate the model, and therefore it is possible to improve the operation efficiency of the model.

### [Model Management Processing in Data Analysis Device]

Next, model management processing by the data analysis device will be described.

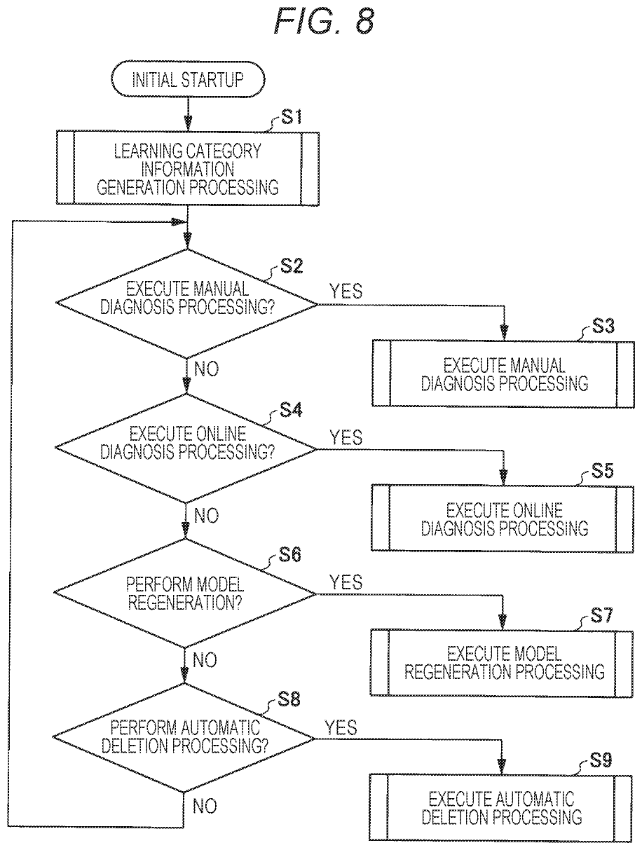

FIG. 8 is a flowchart presenting a procedure example of the model management processing by the data analysis device 100. The processing of this flowchart and each flowchart described later are implemented by the processing unit 161 executing a program stored in the storage unit 170.

First, the software module 103 of the data analysis device 100 executes learning category information generation processing of creating category information using learning data upon initial startup (S1).

### [Learning Category Information Generation Processing]

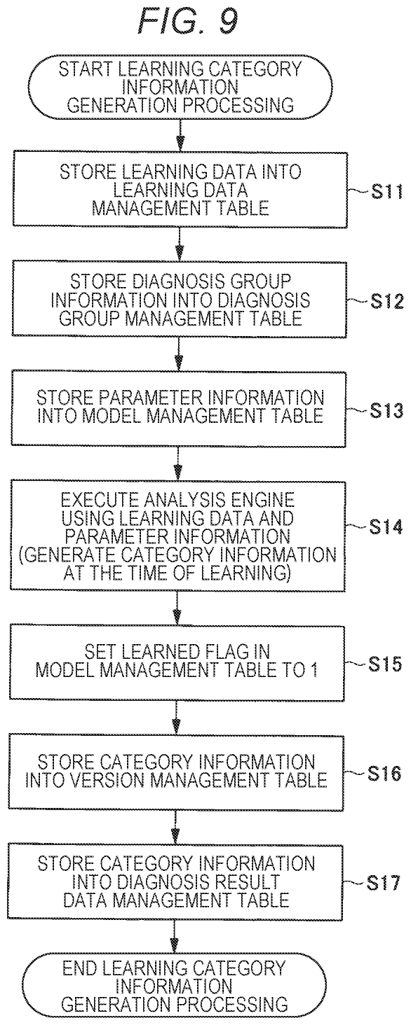

Here, details of the learning category information generation processing in step S1 will be described with reference to FIGS. 9 to 11.

FIG. 9 is a flowchart presenting a procedure example of the learning category information generation processing (step S1) by the offline function 120.

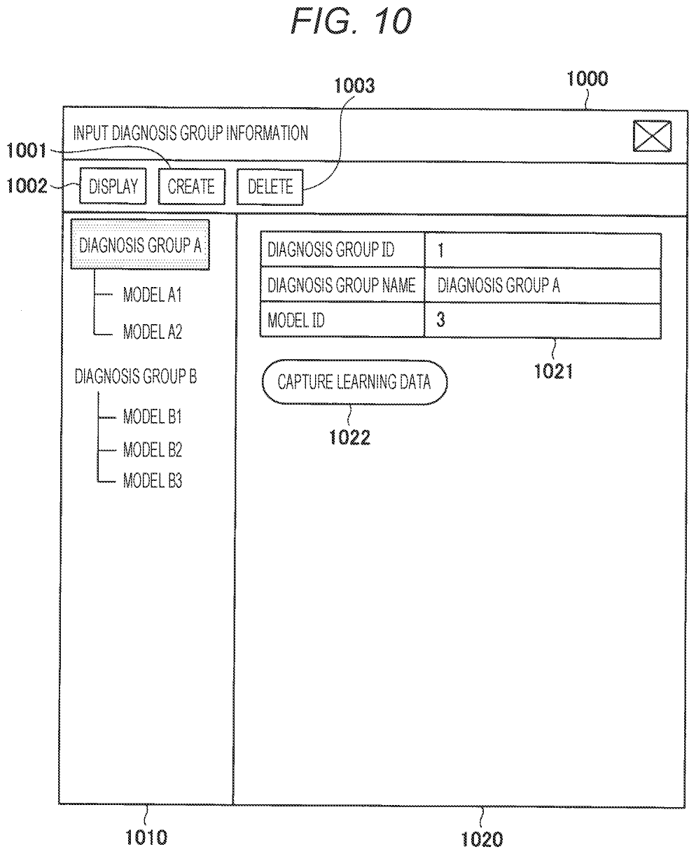

FIG. 10 is a diagram illustrating an example of the diagnosis group information input screen as the user interface 110 for the user to input information regarding the diagnosis group.

A diagnosis group information input screen 1000 illustrated in FIG. 10 is displayed on the user terminal 300, and includes a display button 1002, a create button 1001, and a delete button 1003. The diagnosis group information input screen 1000 includes a diagnosis group configuration display region 1010 and a diagnosis group information display region 1020. In the diagnosis group configuration display region 1010 on the lower left side, the relationship between the diagnosis group registered in the diagnosis group management table 172 of FIG. 3 and the model registered in the model management table 173 of FIG. 4 is hierarchically displayed using the respective names. FIG. 10 illustrates an example of two diagnosis groups in which the diagnosis group name 502 is “diagnosis group A” and “diagnosis group B” and models belonging to the respective diagnosis groups. When the user selects a diagnosis group name on the diagnosis group information input screen 1000 and presses the display button 1002, information of the selected diagnosis group is displayed in the diagnosis group information display region 1020 on the lower right side.

The create button 1001 is a button for creating a new diagnosis group or a model belonging to the new diagnosis group. Here, when the user presses the create button 1001 in a state where “diagnosis group A” is selected on the diagnosis group information input screen 1000, a diagnosis group information table 1021 and a learning data capturing button 1022 are displayed in the diagnosis group information display region 1020. The diagnosis group information table 1021 is a screen for inputting “diagnosis group ID”, “diagnosis group name”, and “model ID”.

“Diagnosis group ID” indicates information of the diagnosis group ID 501 of the diagnosis group management table 172. If the create button 1001 is pressed without neither the diagnosis group name nor the model name selected, the diagnosis group management function 122 refers to the diagnosis group management table 172, automatically gives and displays, into “diagnosis group ID”, the latest diagnosis group ID that is not used.

In “diagnosis group name”, the user can input a discretionary diagnosis group name.

For “model ID”, the model management function 121 refers to the model management table 173, and automatically gives and displays the latest model ID that is not used. In FIG. 10, since two models A1 and A2 belong to the diagnosis group A, a new model ID “3” is given.

Then, when the user presses the learning data capturing button 1022, the diagnosis group management function 122 stores, into the learning data management table 171, the learning data stored in the storage unit 170 (S11). The diagnosis group name and the learning data ID 401 of the learning data stored in the learning data management table 171 are stored into the diagnosis group management table 172 as diagnosis group information (S12). When the delete button 1003 is pressed, the diagnosis group having the selected name is deleted.

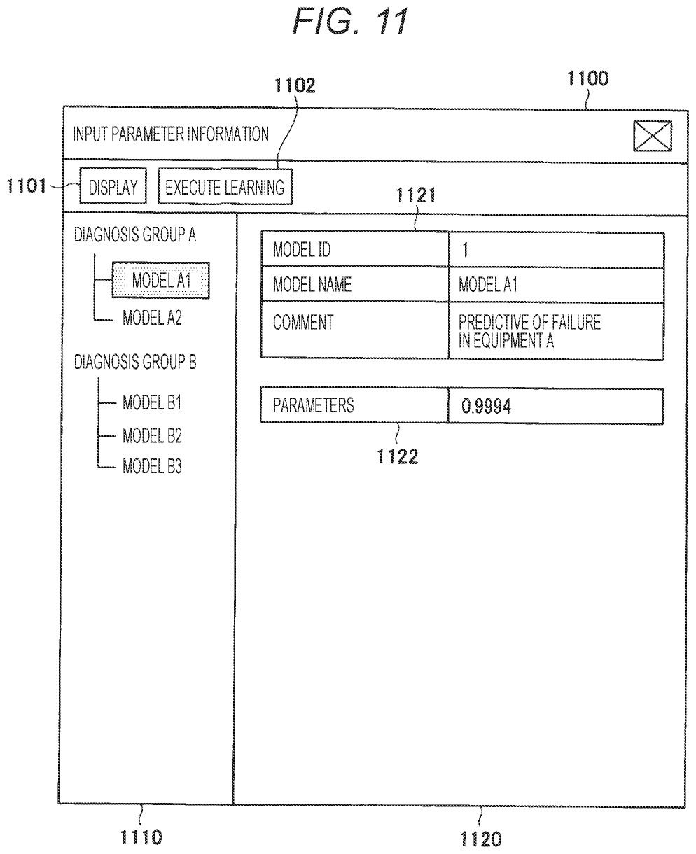

FIG. 11 is a diagram illustrating an example of a parameter information input screen as the user interface 110 for inputting information (parameter information) necessary for the user to execute the adaptive resonance theory.

A parameter information input screen 1100 to be illustrated is displayed on the user terminal 300, and includes a display button 1101 and a learning execution button 1102. The parameter information input screen 1100 includes a diagnosis group configuration display region 1110 and a model information display region 1120. The diagnosis group configuration display region 1110 on the lower left side is the same as the diagnosis group configuration display region 1010 in FIG. 10.

When the user selects a model for which parameter information is desired to input on the parameter information input screen 1100 and presses the display button 1101, a model information table 1121 and a parameter input field 1122 are displayed in the model information display region 1120. The model information table 1121 is a screen for inputting “model ID”, “model name”, and “comment”. In FIG. 11, model information on the selected “model A1” is displayed in the model information table 1121.

In “model ID”, a model ID associated with the model name selected by the user is displayed. As described above, when a new model is created, the model management function 121 refers to the model management table 173 and automatically gives an unused latest ID.

In “model name”, the user can input a discretionary model name.

In “comment”, for example, the user can input text that allows the content of the model to be recalled.

In the parameter input field 1122, parameter information of a model (adaptive resonance theory) selected by the user can be discretionarily set. Note that although FIG. 11 illustrates an example in which the parameter is “0.9994”, it may be considered that the number of parameters is plural in general.

When the user inputs “model name”, “comment”, and the parameter on the parameter information input screen 1100, the model management function 121 stores the input information into the corresponding record of the model management table 173 (S13).

Next, when the user presses the learning execution button 1102 on the parameter information input screen 1100, the data analysis function 124 refers to the learning data management table 171 and the model management table 173 and acquires learning data (time-series data) and parameter information corresponding to the selected model. Then, the data analysis function 124 executes an analysis engine (adaptive resonance theory) using the acquired learning data and parameter information, and generates category information at the time of learning (S14).

After executing the adaptive resonance theory in step S14, the data analysis function 124 sets the learned flag 604 of the corresponding model ID in the model management table 173 to “1” (S15). Next, the data analysis function 124 stores category information (category number 704 and center of gravity 705), which is an execution result of the adaptive resonance theory, into the version management table 174 as information indicating that the version No. 702 is “1” (S16). The data analysis function 124 stores the category information (category 902) also into the diagnosis result data management table 176 (S17).

After the processing of step S17, the learning category information generation processing ends, and the process proceeds to the determination processing of step S2 in FIG. 8. The above is the description of the learning category information generation processing.

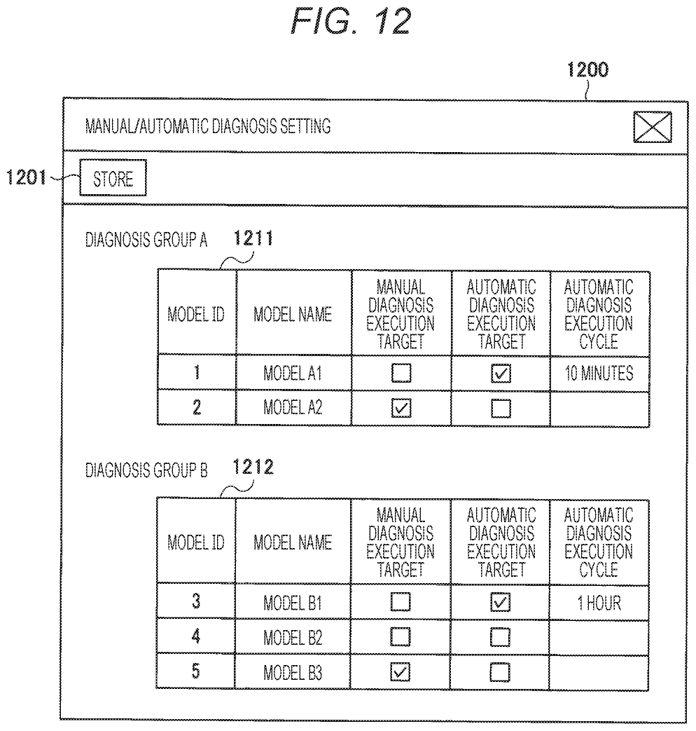

FIG. 12 is a diagram illustrating an example of a manual/automatic diagnosis setting screen as the user interface 110 for setting whether to manually perform or automatically perform diagnosis for the category information generated by a user's instruction.

When the user displays a manual/automatic diagnosis setting screen 1200, the model management function 121 extracts information with the learned flag 604 being set to “1” from the information (records) stored in the model management table 173, and displays the extracted information on the manual/automatic diagnosis setting screen 1200.

The manual/automatic diagnosis setting screen 1200 to be illustrated includes a store button 1201 and a manual/automatic diagnosis setting table for each diagnosis group. In FIG. 12, a manual/automatic diagnosis setting table 1211 of the diagnosis group A and a manual/automatic diagnosis setting table 1212 of the diagnosis group B are displayed. The manual/automatic diagnosis setting table has fields of “model ID”, “model name”, “manual diagnosis execution target”, “automatic diagnosis execution target”, and “automatic diagnosis execution cycle”. For “manual diagnosis execution target” and “automatic diagnosis execution target”, a desired diagnosis can be selected by checking a check box.

Next, when the user selects the manual diagnosis or the automatic diagnosis on the manual/automatic diagnosis setting screen 1200 and presses the store button 1201, the model management function 121 stores the result selected by the user into the model management table 173. When the user selects the automatic diagnosis, the model management function 121 also stores the information of the automatic diagnosis execution cycle input by the user in the model management table 173 together.

Returning to the description of the processing of the data analysis device 100 illustrated in FIG. 8. The software module 103 determines whether there is a model set to manual diagnosis by the user through the manual/automatic diagnosis setting screen 1200 (FIG. 12) (S2), and if there is a model set to manual diagnosis (YES in S2), executes manual diagnosis processing (S3). If there is no model set to manual diagnosis (NO in S2), the process proceeds to step S4.

### [Manual Diagnosis Processing]

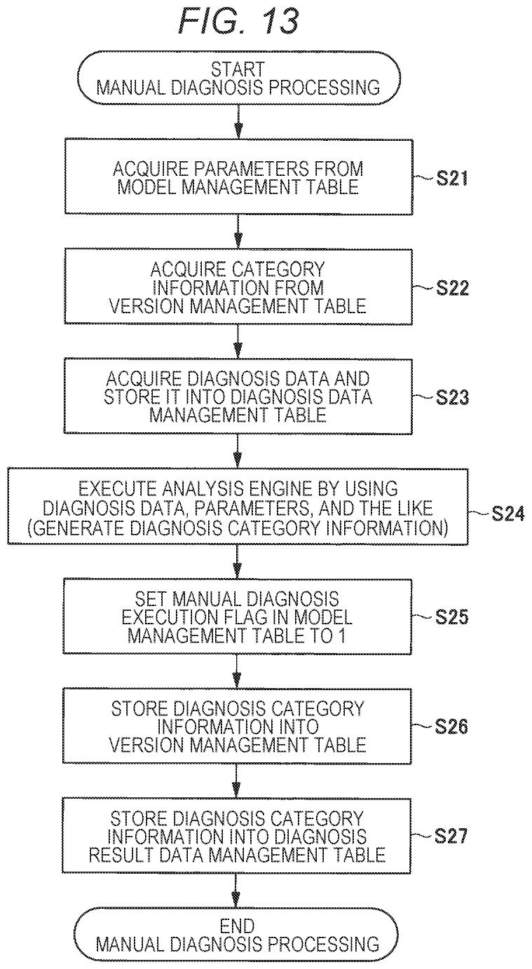

Here, details of the manual diagnosis processing in step S3 will be described with reference to FIGS. 13 to 15.

FIG. 13 is a flowchart presenting a procedure example of the manual diagnosis processing (step S3) by the offline function 120.

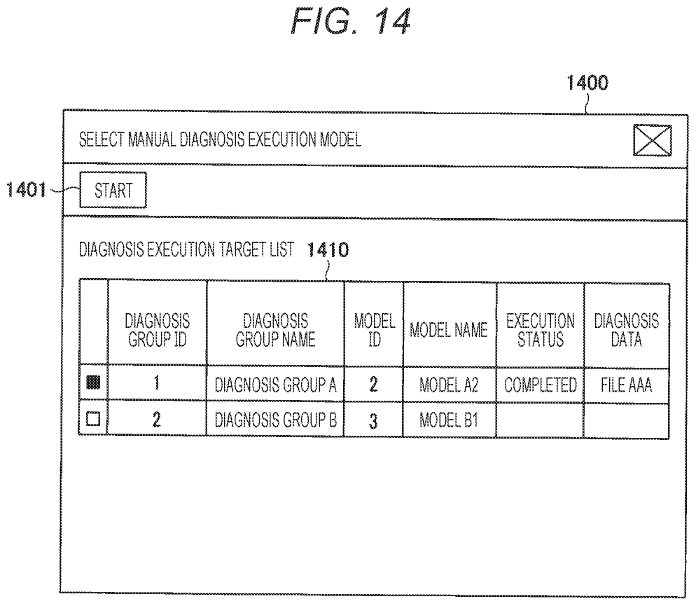

FIG. 14 is a diagram illustrating an example of a manual diagnosis execution model selection screen as the user interface 110 on which the user selects a model to be subjected to the manual diagnosis processing and executes the manual diagnosis.

A manual diagnosis execution model selection screen 1400 illustrated in FIG. 14 is displayed on the user terminal 300, and includes a start button 1401 and a diagnosis execution target list 1410. The diagnosis execution target list 1410 indicates a model in which the manual diagnosis is selected on the manual/automatic diagnosis setting screen 1200. The diagnosis execution target list 1410 includes fields of “check field”, “diagnosis group ID”, “diagnosis group name”, “model ID”, “model name”, “execution status”, and “diagnosis data”.

“Check field” is a check field for selecting a model for which manual diagnosis is executed. In FIG. 14, a model with a model ID “2” belonging to the diagnosis group name “diagnosis group A” is selected.

“Execution status” indicates an execution status of the manual diagnosis of the target model. Information such as “completed” is displayed when the manual diagnosis is completed, and information such as “in execution” is displayed when the manual diagnosis is being executed.

“Diagnosis data” is an element for the user to register diagnosis data used for manual diagnosis. For example, it indicates a file name of a comma-separated values (csv) file storing time-series data acquired from the field device 200. “Diagnosis data” may be address information in which the diagnosis data in the storage unit 170 is written or URL information indicating a storage destination of the diagnosis data on a network in which the data analysis device 100 participates.

When the user displays the manual diagnosis execution model selection screen 1400 illustrated in FIG. 14, the model management function 121 refers to the model management table 173 and extracts the model for which the user has selected the manual diagnosis. Then, the model management function 121 displays the model on the manual diagnosis execution model selection screen 1400.

The user selects a model to be subjected to manual diagnosis through the manual diagnosis execution model selection screen 1400, registers diagnosis data to be used for diagnosis, and then presses the start button 1401. In response to the user's operation, the data analysis function 124 acquires the parameter 603 corresponding to the model selected by the user from the model management table 173 (S21), and acquires the category information in which the version No. of the model selected by the user is “1” from the version management table 174 (S22).

The data analysis function 124 acquires the diagnosis data registered by the user on the manual diagnosis execution model selection screen 1400, and stores the acquired diagnosis data into the diagnosis data 802 of the diagnosis data management table 175 (S23).

Next, the data analysis function 124 executes the analysis engine (adaptive resonance theory) using the acquired diagnosis data, parameters, and category information, and generates category information at the time of diagnosis (after learning) (S24). Hereinafter, the category information at the time of diagnosis (after learning) is sometimes described as “diagnosis category information”.

After executing the adaptive resonance theory in step S24, the data analysis function 124 sets the manual diagnosis execution flag 605 of the corresponding model ID in the model management table 173 to “1” (S25). Next, the data analysis function 124 stores diagnosis category information (category number 704 and center of gravity 705), which is an execution result of the adaptive resonance theory, as information of the latest version ID into the version management table 174 (S26). The data analysis function 124 stores the diagnosis category information (category 902) also into the diagnosis result data management table 176 (S27). The above is the description of the manual diagnosis processing.

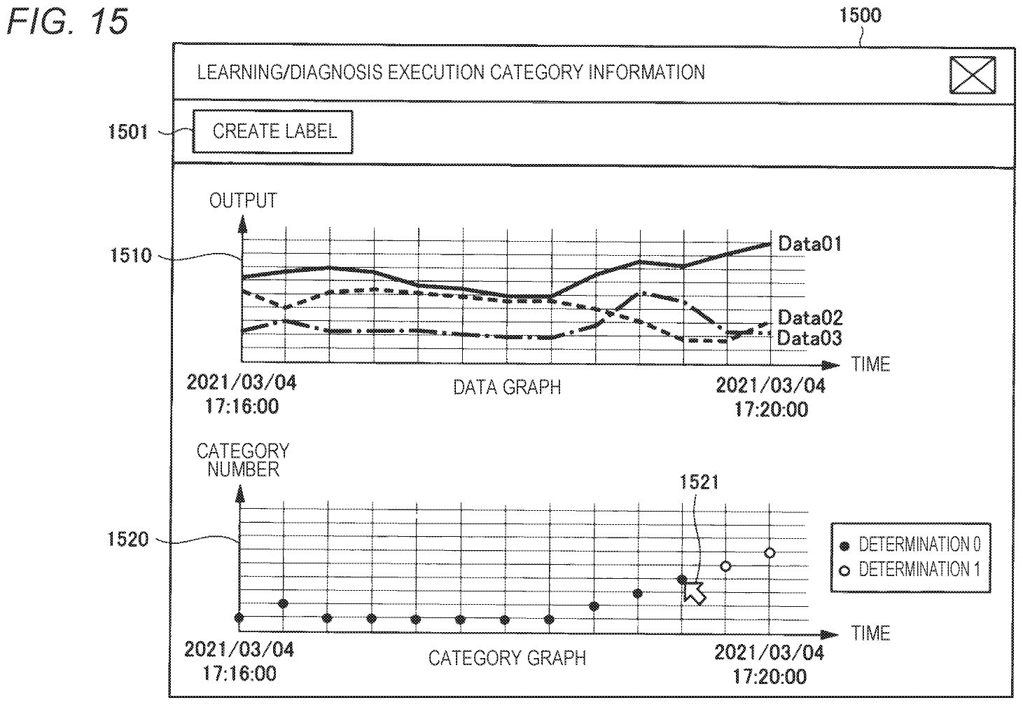

FIG. 15 is a diagram illustrating an example of a learning/diagnosis execution category information screen as the user interface 110 for the user to confirm the category information that has been learned and diagnosed.

For example, when the adaptive resonance theory is executed with the time-series data at the normal time of the field device 200 as learning data in a case of executing learning, and when the adaptive resonance theory is executed with the time-series data at the abnormal time as diagnosis data in a case of executing manual diagnosis, different categories are generated between the normal time and the abnormal time. The validity of the set parameter can be evaluated by confirming this category generation status on a learning/diagnosis execution category information screen 1500 as illustrated in FIG. 15.

In the learning/diagnosis execution category information screen 1500 illustrated in FIG. 15, a label create button 1501, a data graph 1510, and a category graph 1520 are displayed. The horizontal axes of the data graph 1510 and the category graph 1520 represent time (date and time), and the vertical axes represent output and the category number, respectively. The category graph 1520 indicated a result of classifying three types of time-series data “Data01”, “Data02”, and “Data03” described in the data graph 1510 into categories by the adaptive resonance theory. The category number with the mark “40” indicated in the category graph 1520 is normal (determination 0), and the category number with the mark “0” is abnormal (determination 1).

Returning to the description of the processing of the data analysis device 100 illustrated in FIG. 8. The software module 103 determines whether there is a model set to automatic diagnosis by the user through the manual/automatic diagnosis setting screen 1200 (FIG. 12) (S4), and if there is a model set to automatic diagnosis (YES in S4), executes online diagnosis processing (automatic diagnosis) (S5). If there is no model set to automatic diagnosis (NO in S4), the process proceeds to step S6.

### [Online Diagnosis Processing]

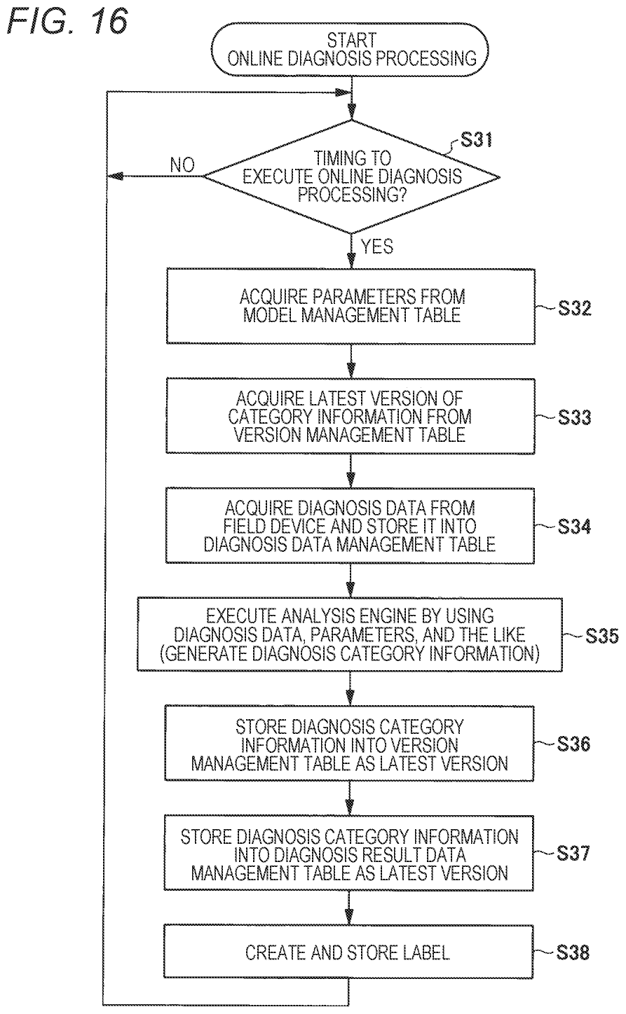

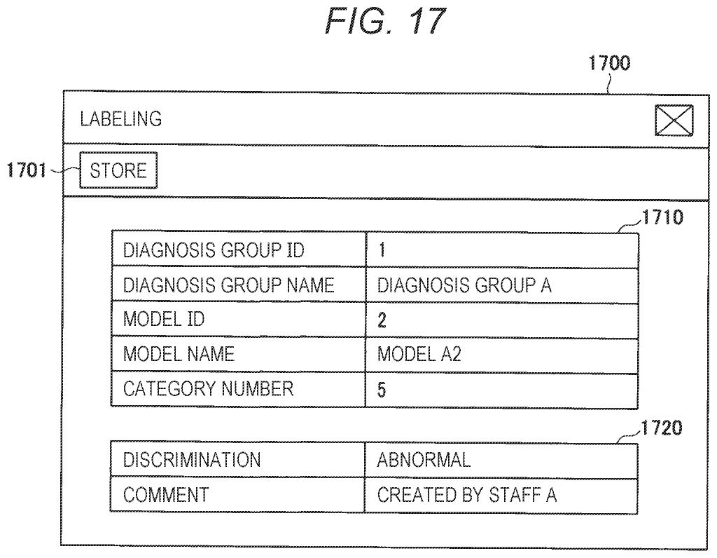

Here, details of the online diagnosis processing in step S5 will be described with reference to FIGS. 16 and 17.

FIG. 16 is a flowchart presenting a procedure example of the online diagnosis processing in step S5 by the online function 130.

The sequential data analysis function 131 refers to the model management table 173 and extracts a model in which the automatic diagnosis execution flag 606 is set to “1”. Then, the sequential data analysis function 131 confirms the automatic diagnosis execution cycle 607 of the extracted model, and determines whether it is a timing to execute the online diagnosis processing (S31). If determining that it is not the execution timing of the online diagnosis processing from the automatic diagnosis execution cycle 607 (NO in S31), the sequential data analysis function 131 performs the determination processing in step S31 again after a predetermined length of time has elapsed.

Next, if it is the timing to execute the online diagnosis processing (hereinafter, “automatic diagnosis”) (YES in S31), the sequential data analysis function 131 acquires, from the model management table 173 (S32), the parameter 603 corresponding to the model for which the automatic diagnosis is performed, and acquires the category information of the latest version of the corresponding model from the version management table 174 (S33).

The sequential data analysis function 131 acquires time-series data (diagnosis data) from the field device 200 through the data collection function 140, and stores the acquired diagnosis data into the diagnosis data 802 of the diagnosis data management table 175 (S34).

Next, the sequential data analysis function 131 executes the analysis engine (adaptive resonance theory) using the acquired diagnosis data, parameters, and category information, and generates category information at the time of diagnosis (after learning) (S35).

After executing the adaptive resonance theory in step S24, the sequential data analysis function 131 stores diagnosis category information (category number 704 and center of gravity 705), which is an execution result of the adaptive resonance theory, as information of the latest version ID into the version management table 174 (S36). The sequential data analysis function 131 stores the diagnosis category information (category 902) also into the diagnosis result data management table 176 (S37).

After the adaptive resonance theory in step S35 is executed, the user can confirm the generation status of the category using the learning/diagnosis execution category information screen 1500 illustrated in FIG. 15. In a case where a new category is generated when the user confirms the generation status of the category, and the category is a characteristic category, the user can label the category using the labeling function 132 (FIG. 1) (S38).

Then, after the processing of step S38, the sequential data analysis function 131 returns to the determination processing of step S31 and prepares for the execution timing of the online diagnosis processing again. The above is the description of the online diagnosis processing.

FIG. 17 is a diagram illustrating an example of a labeling screen as the user interface 110 to be labeled by the user.

A labeling screen 1700 illustrated includes a store button 1701, label information 1710, and discrimination/comment information 1720. For example, the label information 1710 includes items of “diagnosis group ID”, “diagnosis group name”, “model ID”, “model name”, and “category number”. When a label of a new category number is created, the adaptive resonance theory automatically gives an unused latest category number.

In the learning/diagnosis execution category information screen 1500 of FIG. 15, when the user selects a category newly generated by a pointer 1521 and then presses the label create button 1501, the screen transitions to the labeling screen 1700 illustrated in FIG. 17. The user selects discrimination of the category (normal time category or abnormal time category) in the discrimination/comment information 1720 on the labeling screen 1700, enters a comment that allows another user to understand the determination basis, and then presses the store button 1701. Then, the labeling function 132 updates each piece of information including the category 902 and the determination 903 of the diagnosis result data management table 176.

Returning to the description of the processing of the data analysis device 100 illustrated in FIG. 8. The software module 103 determines whether there is an instruction to regenerate the model of a discretionary version generated by the user (S6), and if there is an instruction to regenerate the model (YES in S6), executes the model regeneration processing (S7). If there is no instruction to regenerate the model (NO in S6), the process proceeds to step S8.

### [Model Regeneration Processing]

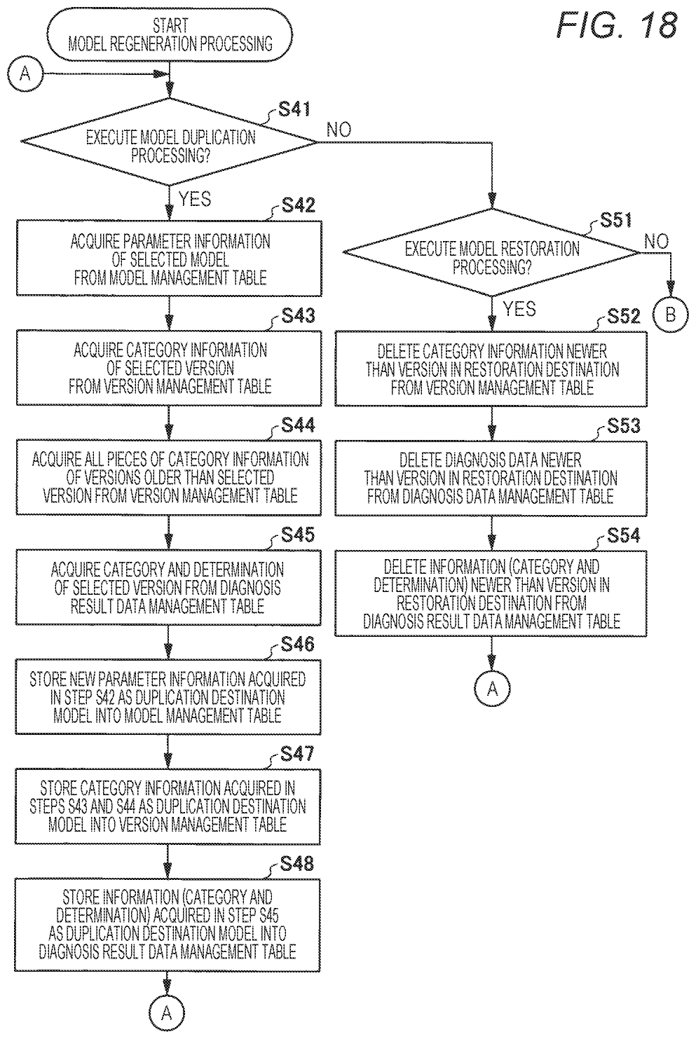

Here, details of the model regeneration processing in step S7 will be described with reference to FIGS. 18 to 20.

FIG. 18 is a flowchart (1) presenting a procedure example of the model regeneration processing in step S7.

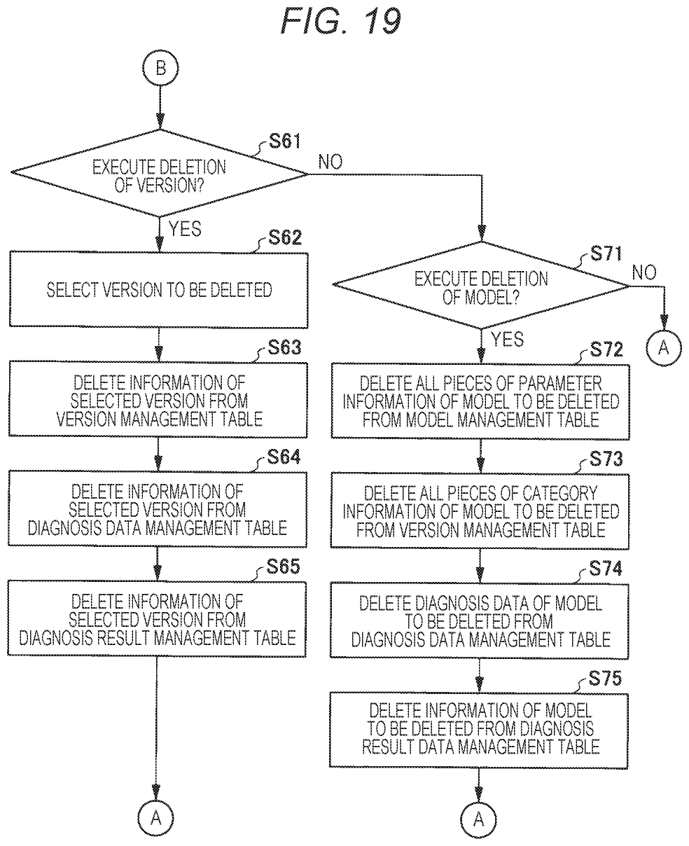

FIG. 19 is a flowchart (2) presenting a procedure example of the model regeneration processing in step S7.

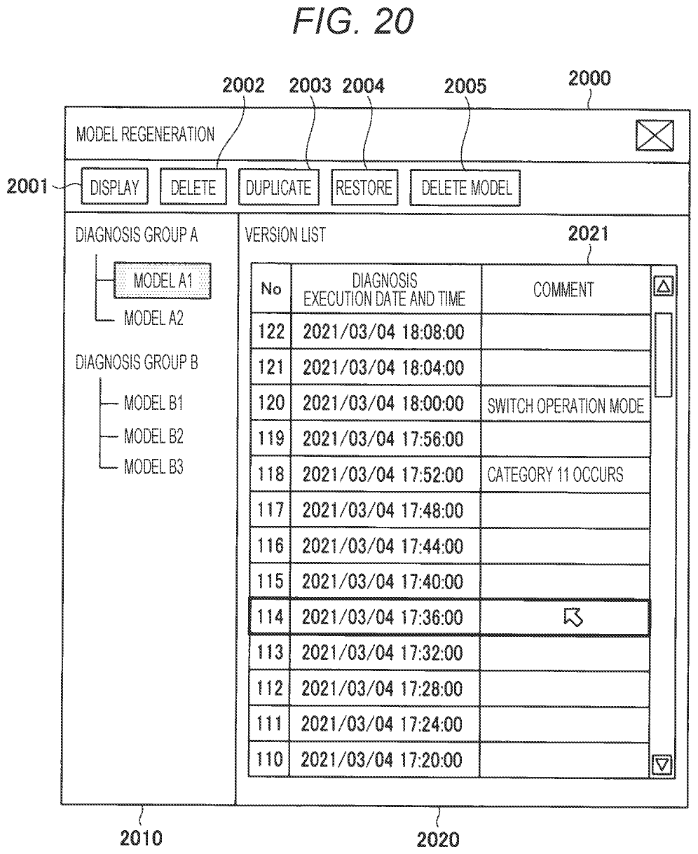

FIG. 20 is a diagram illustrating an example of the model regeneration screen as the user interface 110 on which the user executes the model regeneration processing.

A model regeneration screen 2000 illustrated in FIG. 20 is displayed on the user terminal 300, and includes a display button 2001, a delete button 2002, a duplicate button 2003, a restore button 2004, and a model delete button 2005. The model regeneration screen 2000 includes a diagnosis group configuration display region 2010 and a version list display region 2020. The diagnosis group configuration display region 2010 on the lower left side is the same as the diagnosis group configuration display region 1010 in FIG. 10.

The version list display region 2020 displays a version list 2021. The version list 2021 includes fields of “version No.”, “diagnosis execution date and time”, and “comment”. “Version No.”, “diagnosis execution date and time”, and “comment” correspond to the version No. 702, the diagnosis execution date and time 703, and the comment 706 of the version management table 174, respectively.

When the user selects a model on the model regeneration screen 2000 and then presses the display button 2001, the version list 2021 describing a history (diagnosis execution date and time) in which the selected model executed learning or diagnosis is displayed. FIG. 20 illustrates an example in which “model A1” is selected.

Thus, the data analysis device according to the present embodiment includes the user interface that selectably displays the model and the version information.

### (Model Duplication)

For example, in a case where the user generates another model using category information of a certain version, the user selects a version desired to duplicate and presses the duplicate button 2003. FIG. 20 illustrates an example in which a version No. “114” is selected.

The model management function 121 determines whether to execute the model duplication processing, that is, whether the duplicate button 2003 on the model regeneration screen 2000 has been pressed (S41), and if the duplicate button 2003 has not been pressed (NO in S41), the process proceeds to step S51.

On the other hand, if the duplicate button 2003 has been pressed (YES in S41), the model management function 121 acquires the parameter information (parameter 603) of the selected model from the model management table 173 (S42). The model management function 121 acquires category information (category number 704 and center of gravity 705) of the selected version from the version management table 174 (S43). The model management function 121 acquires all pieces of the category information of versions older than the selected version from the model management table 173 (S44). Furthermore, the model management function 121 acquires information (category 902 and determination 903) of the selected model and version from the diagnosis result data management table 176 (S45).

Next, the model management function 121 creates a record of the new model of the duplication destination in the model management table 173, and stores the parameter information (parameter 603) acquired in step S42 (S46). The model management function 121 generates a record of the new model of the duplication destination into the version management table 174, and stores the category information (category number 704 and center of gravity 705) acquired in steps S43 and S44 (S47). The model management function 121 generates the record of a new model of the duplication destination also into the diagnosis result data management table 176, and stores the information (category 906 and determination 903) acquired in step S45 (S48).

After the processing of step S48, the process returns to the determination processing of step S41. The above is the description of the model regeneration processing (model duplication) in a case where the user presses the duplicate button 2003.

### (Model Restoration)

The sequential data analysis function 131 sequentially updates the category information. Therefore, for example, also when the field device 200 transmits time-series data at the time of maintenance, there is a possibility of executing diagnosis using the time-series data, and generating category information different from that at the normal time. Therefore, there is a demand for restoring category information before the user executes diagnosis by time-series data at the time of maintenance.

After the NO determination in step S41, the model management function 121 determines whether to execute the model restoration processing, that is, whether the restore button 2004 on the model regeneration screen 2000 (FIG. 20) has been pressed (S51), and if the restore button 2004 has not been pressed (NO in S51), the process proceeds to step S61.

On the other hand, if the user selects the version No. desired to restore on the model regeneration screen 2000 and then presses the restore button 2004 (YES in S51), the model management function 121 deletes the category information of versions newer than the version desired to restore from the version management table 174 (S52). The model management function 121 deletes the diagnosis data of versions newer than the version desired to restore from the diagnosis data management table 175 (S53). The model management function 121 deletes, from the diagnosis result data management table 176, information (category 902 and determination 903) of versions newer than the version desired to restore (S54).

After the processing of step S54, the process returns to the determination processing of step S41. The above is the description of the model regeneration processing (model restoration) in a case where the user presses the restore button 2004.

Thus, in the data analysis device 100 according to the present embodiment, the user interface is configured to display the buttons (duplicate button 2003 and restore button 2004) for instructing regeneration of a model on the basis of the selected version information.

### (Version Deletion)

As described above, in the data analysis device 100, the sequential data analysis function 131 sequentially updates the category information, and all the histories are stored in the version management table 174. For this reason, there is a risk that the capacity of the storage unit 170 becomes tight. Therefore, the present embodiment is installed with a mechanism in which the user deletes unnecessary past version of category information.

After the NO determination in step S51, the model management function 121 determines whether to execute processing of deleting information of an unnecessary version, that is, whether the delete button 2002 on the model regeneration screen 2000 (FIG. 20) has been pressed (S61), and if the delete button 2002 has not been pressed (NO in S61), the process proceeds to step S71.

On the other hand, if the user selects the version No. desired to delete on the model regeneration screen 2000 and then presses the delete button 2002 (YES in S61, S62), the model management function 121 deletes the information (category information) of the selected version from the version management table 174 (S63). The processing in steps S61 and S62 may be performed in any order.

The model management function 121 deletes, from the diagnosis data management table 175, the information (diagnosis data) of the selected version (S64). The model management function 121 deletes, from the diagnosis result data management table 176, the information (category or determination) of the selected version (S65).

After the processing of step S65, the process returns to the determination processing of step S41. The above is the description of the model regeneration processing (version deletion) in the case where the user presses the delete button 2002.

### (Model Deletion)

Furthermore, there is also a case where the user desires to delete information of the entire model due to the capacity tightness of the storage unit 170 of the data analysis device 100. Therefore, the present embodiment is installed with a mechanism in which the user deletes information of the entire model.

After the NO determination in step S61, the model management function 121 determines whether to execute processing of deleting information of an unnecessary model, that is, whether the model delete button 2005 on the model regeneration screen 2000 (FIG. 20) has been pressed (S71), and if the model delete button 2005 has not been pressed (NO in S71), the process proceeds to step S41.

On the other hand, when the user selects a model desired to delete on the model regeneration screen 2000 and then presses the model delete button 2005 (YES in S71), the model management function 121 deletes all the parameter information of the model desired to delete from the model management table 173 (S72).

The model management function 121 deletes all the category information of the model desired to delete from the version management table 174 (S73).

The model management function 121 deletes all the diagnosis data of the model desired to delete from the diagnosis data management table 175 (S74).

Furthermore, the model management function 121 deletes all the information (category and determination) of the model desired to delete from the diagnosis result data management table 176 (S75).

After the processing of step S75, the process returns to the determination processing of step S41. The above is the description of the model regeneration processing (model deletion) in the case where the user presses the model delete button 2005. The above is the description of the model regeneration processing (FIG. 8) in step S7.

As described above, in the data analysis device 100 according to the present embodiment, the user interface includes a function of deleting a part of the version information or the version information in units of models.

Returning to the description of the processing of the data analysis device 100 illustrated in FIG. 8. In the model regeneration processing (S7), the processing of deleting the version designated by the user has been described, but there is a high possibility that the convenience of the user is impaired if the user sequentially performs this processing. Therefore, the present embodiment is installed with a mechanism for automatically deleting the category information at the time of executing the old diagnosis only when there is permission of the user.

The software module 103 determines whether to perform automatic deletion processing, that is, whether the user permits automatic deletion (S8), and if the user has set manual deletion permission (YES in S8), performs the automatic deletion processing (S9). In the user has not set the manual deletion permission (NO in S8), the process proceeds to step S2.

### [Automatic Deletion Processing]

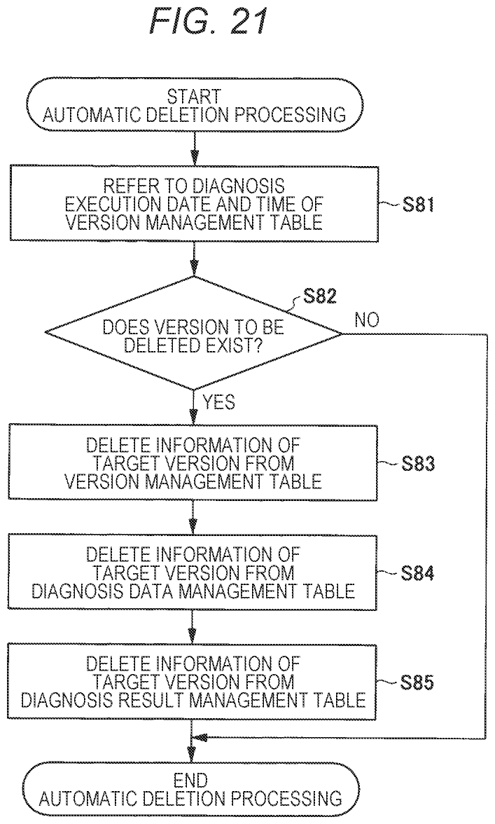

Here, details of the automatic deletion processing in step S9 will be described with reference to FIG. 21.

FIG. 21 is a flowchart presenting a procedure example of the automatic deletion processing in step S9 by the offline function 120.

First, the model management function 121 refers to the diagnosis execution date and time 703 in the version management table 174 (S81). Then, the model management function 121 determines whether there is a version that the user has set as a deletion target in the version management table 174, that is, whether there is a record older than the date and time set by the user in the diagnosis execution date and time 703 (S82). Here, in a case where there is no record older than the date and time set by the user (NO in S82), the processing of this flowchart is ended.

On the other hand, if determining that there is a record older than the date and time set by the user (YES in S82), the model management function 121 deletes information (category information) of the old version set as the deletion target from the version management table 174 (S83). The model management function 121 deletes the information (diagnosis data) of the old version set as the deletion target from the diagnosis data management table 175 (S84). The model management function 121 deletes the information (category and determination) of the old version set as the deletion target from the diagnosis result data management table 176 (S85). The above is the description of the automatic deletion processing of the data analysis device 100.

Note that in the flowchart of the model management processing presented in FIG. 8, the learning category generation processing in step S1 is only executed immediately after the initial startup, but the learning category generation processing can be executed at any time when the user desires to generate a new model.

In the above-described embodiment, the data analysis target can be a device and a system provided with a large number of devices in addition to a field device that monitors a machine tool or the like. For example, examples of the data analysis target of the present invention include social infrastructure systems such as railways and electric power/gas, and manufacturing plants.

The present invention is not limited to the above-described embodiment, and it goes without saying that various other application examples and modifications can be taken without departing from the gist of the present invention described in the claims. For example, the above-described embodiment describes the configuration of the data analysis device and the entire system in detail and specifically, in order to describe the present invention in an easy-to-understand manner, and is not necessarily limited to one including all the components described above. It is also possible to add, replace, or delete another component to, with, or from a part of the configuration in the above-described embodiment.

The above-described configurations, functions, processing units, and the like may be partially or entirely implemented by hardware, for example, by designing with an integrated circuit. A processor device in a broad sense such as a field programmable gate array (FPGA) or an application specific integrated circuit (ASIC) may be used as the hardware.

Each component of the data analysis device according to the above-described embodiment may be implemented in any hardware as long as the hardware can transmit and receive information to and from each other via a network. Processing performed by a certain function or a processing unit may be implemented by one piece of hardware or may be implemented by distributed processing by a plurality of pieces of hardware.

In each flowchart, a plurality of processing may be executed in parallel or the processing order may be changed within a range not affecting the processing result.

What is claimed is:

1. A data analysis device comprising:
a sequential data analysis unit that cyclically generates a model for analyzing time-series data representing an operational status of an analysis target system using a clustering technology; and
a management unit that manages the model, parameter information of the model, a classification result of the time-series data by the clustering technology, and version information given each time the model is generated, wherein
the management unit executes processing of regenerating the model by using the parameter information associated with the version information having been selected and a classification result of the time-series data when the version information of the model is selected.

2. The data analysis device according to claim 1 comprising:
a user interface that selectably displays the model and the version information.

3. The data analysis device according to claim 2, wherein
the sequential data analysis unit generates the model by classifying the time-series data into categories using an adaptive resonance theory as the clustering technology.

4. The data analysis device according to claim 3, wherein
the management unit manages the categories of the time-series data and a determination result of normality or abnormality for each of the categories in association with the version information.

5. The data analysis device according to claim 1, wherein
the version information represents a history in which generation of the model is performed.

6. The data analysis device according to claim 1, wherein
the version information is a date and time when classification of the diagnosis data is performed by the clustering technology using a classification result of the time-series data when the model is learned and diagnosis data that is time-series data having a same structure as a structure of time-series data at a time of learning.

7. The data analysis device according to claim 2, wherein
the user interface displays a button for giving an instruction to regenerate the model based on the version information having been selected.

8. The data analysis device according to claim 2, wherein
the user interface includes a function of deleting a part of the version information or the version information in units of models.

9. A model management method by a data analysis device that cyclically generates a model for analyzing time-series data representing an operational status of an analysis target system using a clustering technology, the model management method comprising: executed by the data analysis device,
processing of managing the model, parameter information of the model, a classification result of the time-series data by the clustering technology, and version information given each time the model is generated; and
processing of regenerating the model by using the parameter information associated with the version information having been selected and a classification result of the time-series data when the version information of the model is selected.
